(19) United States
(12) Patent Application Publication
(10) Pub. No.: US 2010/0013662 A1
(43) Pub. Date: Jan. 21, 2010

(54) Product locating system

(76) Inventor: Michael Stude, Lake Forest, CA (US)

Correspondence Address: PYLE & PIONTEK, LLC, 221 N LASALLE STREET , ROOM 1207, CHICAGO, IL, 60601, US

(21) Appl. No.: 12/218,661

(22) Filed: Jul. 17, 2008

(51) Int. Cl. G08B 5/22

(52) U.S. Cl. 340/825.49

(57) ABSTRACT

A system for quickly locating selected products in a store uses a computer module which has a keyboard and a visual display position and a plurality of position indicating devices, such as passive or active RFID devices, which are fixed to a shelf or to products on a shelf to indicate the location of the product, whereby a consumer can type in the description of a selected product on a keyboard on the computer module and a signal, such as a radio signal, will be generated by the computer module and sent to the position indicating device. The computer module can be a hand held computer module and can have fixing structures for releasably fixing the computer module to a shopping cart at the store. The signal is sent to the position indicating device on the shelf where the selected product is located. The position indicating device then sends back a signal to the computer module indicating the location of the selected product which location is displayed on the visual display or screen, namely the aisle number and location in the aisle, so that the consumer can go to the aisle where the product is located and select the product he or she wishes to purchase without having to walk up and down aisles in the store to find the product and without having to ask a store employee where the product is located.

### FIELD OF THE INVENTION

The present invention relates to a system for locating products in a store, such a supermarket or a department store.

### DESCRIPTION OF THE PRIOR ART

Presently, when a consumer is shopping at a store, he or she needs to walk up and down aisles to find different products. Typically, the consumer locates one of the service employees or personnel in the store to find out where a product can be found.

### BRIEF SUMMARY OF THE INVENTION

The present invention comprises a system for quickly locating products at a store using a computer module, which has a keyboard and a visual display and passive or active position indicating device, such as an RFID device, which are fixed to a shelf or on products themselves on the shelf to indicate the location of the product. The consumer can type in the product description at the computer module, such as a can of tomato soup and a radio signal will be generated which is sent to the position indicating device, such as the RFID, on the shelf where the tomato soup can is located. The position indicating device, such as the RFID device, then sends back a signal to the computer module and the location is shown on the visual display or screen, typically, for example, as aisle 5, middle, top shelf, so that the consumer can go to aisle 5 and obtain the can of tomato soup he or she wishes to purchase without having to walk up and down aisles in the store to find the can of tomato soup. The computer module can be at a specified location in the store or can be a hand held module.

### BRIEF DESCRIPTION OF THE DRAWINGS

FIG. 1 is a fragmentary view of a shelf in a supermarket showing products on the shelf and showing a position indicating device, such as an RFID device on each shelf for identifying the product on that shelf;

FIG. 2 is a perspective view of a stand mounting a computer module with a keyboard and a visual display, whereby a product can be typed in on the keyboard and then a signal sent to the position indicating device, such as the RFID device, which then returns a signal indicating the location of the product the consumer wishes to purchase.

### BRIEF SUMMARY OF THE INVENTION

According to the teachings of the present invention, a system is provided for locating a product in a store, said system comprising a computer module having a keyboard and a visual display by which a consumer can type in the name of a product he or she is looking for which will then appear on the visual display. A plurality of position indicating devices, such as RFID devices, each identifying a separate product are mounted to shelves in the store on which products are stored, whereby upon typing in the product name, a signal is sent by the computer module to the numerous position indicating devices, such as RFID devices in the store and the position indicating device, such as the RFID device, for the selected product returns a signal indicating the location of the selected product. The location of the selected product is then displayed on the visual display, namely, the aisle, the location in the aisle and the shelf in the aisle where the product is located. The computer module can be a hand held module.

### DETAILED DESCRIPTION OF THE INVENTION

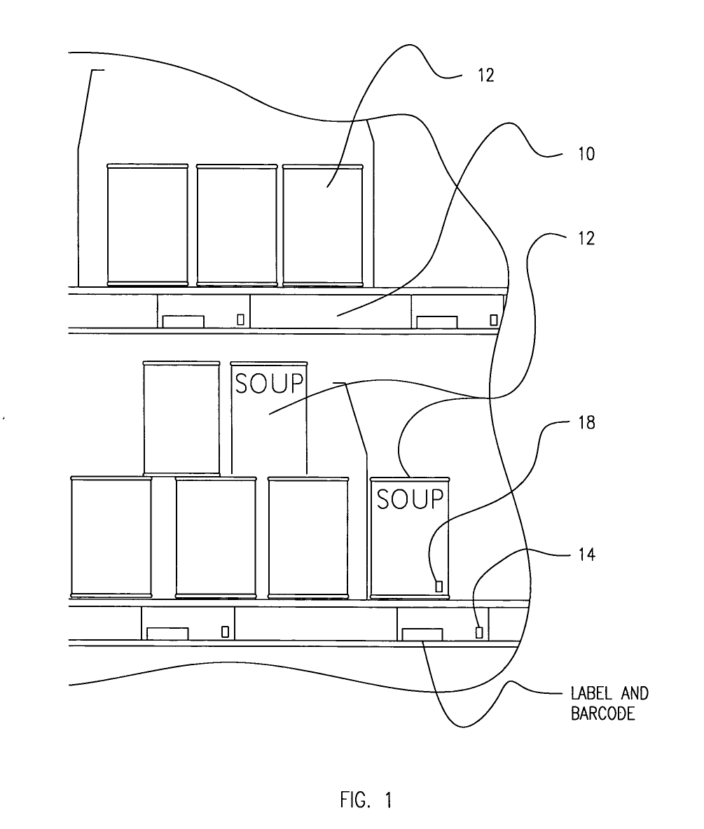

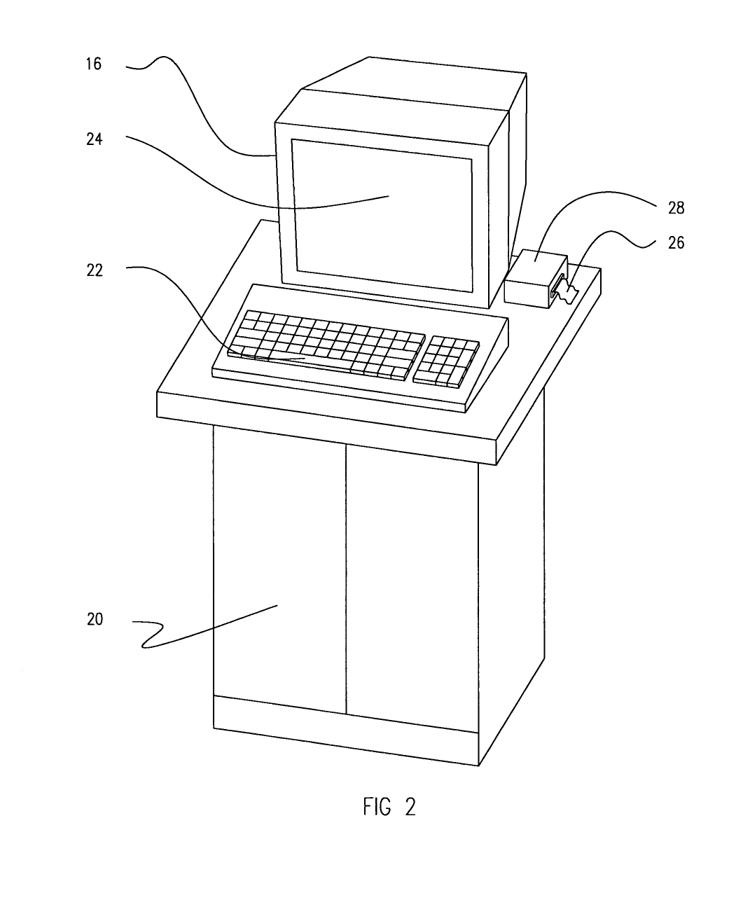

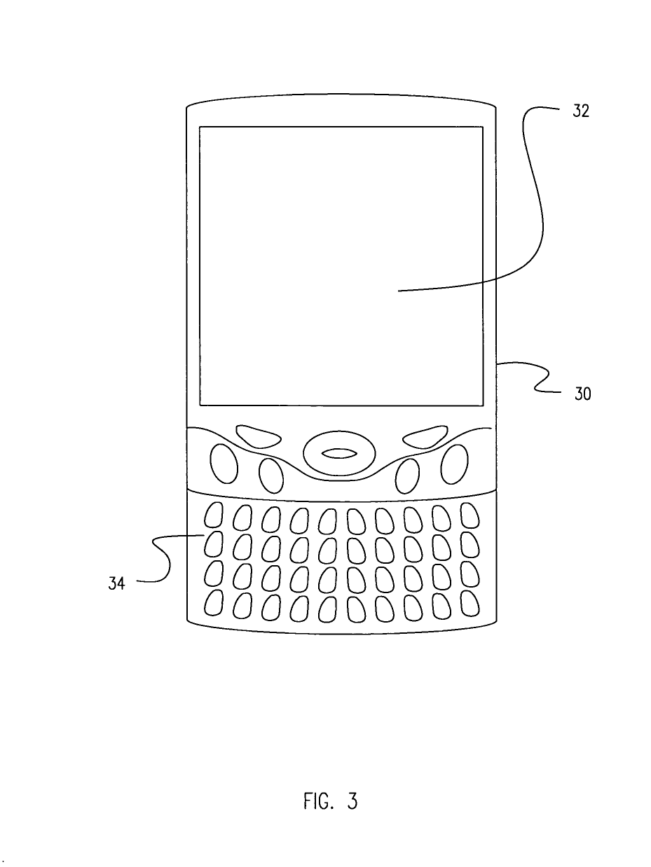

Referring now to FIG. 1 there is illustrated therein part of a shelf 10 in an aisle in a store, such as a grocery store. On each shelf 10 in the store where specific products 12 are located, there is also located an active or passive position indicating device, such as an RFID device RFID 14, which is adapted to receive a signal from a computer module 16, shown in FIG. 2. The position indicating device, such as the RFID device, 12 will send back a signal to the computer module 16 indicating the aisle, the position in the aisle and the particular shelf 10 in the aisle where the specific product 12 on the shelf 10 is located. Alternatively, the position indicating device such, as an RFID device 18 can be located on a product 12.

FIG. 2 shows a stand 20 having the computer module 16 thereon including a keyboard 22, and a visual display or screen 24.

In the use of the system, a consumer would go to the stand 20 and type in on the keyboard 22 the name of the selected product 12 he or she is looking for, such as for example, a can 12 of tomato soup. The computer module 16 will then send out a signal such as a radio signal, to a plurality of position indicating devices such as the RFID devices 14 located on the shelves 10 in different areas of the store. Next, the position indicating device, such as the RFID device 14 or 18 for the location of cans 12 of tomato soup will send back a signal to the computer module 16 indicating the location of cans 12 of tomato soup, namely, the aisle number, the position in the aisle and the shelf in the aisle where the cans 12 of tomato soup are located.

Then the consumer can print out the product location in the store and its location on a piece of paper 26, from a printer 28 and go to that location in the store to obtain the product.

In another embodiment shown in FIG. 3, the computer module is a hand held module 30 having a screen 32 and a keyboard 34. With the hand held module 30, the user can carry the module 30 with him or her while shopping. Also, suitable structure, such as a clip or hook and loop fasteners (not shown) can be mounted to the module 30 for attaching the module 30 to a shopping cart.

It will be understood that the product locating system and apparatus of the present invention enables a consumer to quickly locate the aisle location where a product is stored in a department store or supermarket.

From the foregoing description, it will be apparent that the product locating system and apparatus of the present invention have a number of advantages, some of which have been described above and others of which are inherent in the invention.

Further, modifications can be made to the system of the present invention without departing from the teachings of the present invention. For example, the position indicating device, such as the RFID device 18 can be put on a product 12 and also can be used also as an anti-theft device to send a signal to a store computer to generate an alarm when a consumer tries to leave the store with a product without paying for the product.

Also, the system can be used for locating products with different nutritional values or for locating organically grown foodstuffs.

Accordingly, the scope of the invention is only to be limited as necessitated by the accompanying claims.

I claim:

1. A system for quickly locating a selected product in a store comprising a computer module which has a keyboard and a visual display, the system including a plurality of passive or active position indicating devices which are fixed to one of a shelf in a store or to a product on the shelf to indicate the location of the product, whereby a consumer can type in the product description, such as a can of tomato soup, and a radio signal is sent by the computer module will be generated and sent to the position indicating device and at least one of the position indicating devices in the store sends back a signal to the computer module which then is used by the computer module to indicate the location of the selected product on the visual display, aisle number, location in the aisle or shelf in the aisle, so that the consumer can go to the aisle indicated and obtain the selected product he or she wishes to purchase without having to walk up and down aisles in the store or having to ask a store employee where to find the product.

2. The system of claim 1 wherein the position indicating device is fixed to a shelf location for a product.

3. The system of claim 1 wherein the position indicating device is located on the product on a shelf.

4. The system of claim 3 where the position indicating device also serves as an anti-theft device which sends a signal to a store computer when a consumer attempts to leave a store with the product without paying for the product.

5. The system of claim 1, including a printer is connected to the computer module for printing out the location of the selected product.

6. The system of claim 1, wherein said computer module is a hand-held held module which the customer can carry with him or her while shopping in the store.

7. The system of claim 6, wherein suitable attached attachment means are provided on the hand-held computer module for releasably fixing the computer module to a store cart used for collecting merchandise and taking the merchandise to a check out station having a cash register.

8. The system of claim 1 wherein said position locating device is an active or passive RFID device.
